(19) United States
(12) Patent Application Publication
(10) Pub. No.: US 2011/0050512 A1
(43) Pub. Date: Mar. 3, 2011

(54) MOBILE TERMINAL DEVICE

(75) Inventors: Masatomo MORI, Kawasaki (JP); Hiroyuki Yoshizawa, Kawasaki (JP)

(73) Assignee: FUJITSU LIMITED, Kawasaki-shi (JP)

(21) Appl. No.: 12/872,477

(22) Filed: Aug. 31, 2010

(30) Foreign Application Priority Data
Sep. 1, 2009 (JP) 2009-202068

(51) Int. Cl. H01Q 1/24

(52) U.S. Cl. 343/702

(57) ABSTRACT

A mobile terminal device includes: a first casing having a first antenna element; a second casing having a second antenna element; and a joint for rotatably joining the first casing and the second casing, the joint having third antenna element for electrically connecting the first antenna element and the second antenna element.

### CROSS-REFERENCE TO RELATED APPLICATION

This application is based upon and claims the benefit of priority of the prior Japanese Patent Application No. 2009-202068 filed on Sep. 1, 2009, the entire contents of which are incorporated herein by reference.

### FIELD

The embodiments discussed herein are related to a mobile terminal device.

### BACKGROUND

Mobile terminal devices, such as mobile phones, have recently come to include not only a voice call function and a mail function but also a near field communication function and a 1 seg broadcast viewing function, thus increasing their functions. With the increase in the function of mobile terminal devices, the number of antennas also tends to increase. With the increase in the number of antennas of one mobile terminal device, various arrangements of antennas are under study.

Known examples of folding mobile terminal devices in which two casings are movably joined together with a hinge have a call antenna and a 1 seg broadcast receiving antenna (hereinafter referred to as a 1 seg antenna) disposed at different positions.

FIG. 4 is a diagram illustrating an example of the mobile terminal devices in which a call antenna and a 1 seg antenna are disposed at different positions. As shown in FIG. 4, a mobile terminal device 110 in which a first casing 111 and a second casing 112 are movably joined together with a hinge has a monopole antenna 114 as a call antenna in the vicinity of the hinge 113 and an extendable rod antenna 115 as a 1 seg antenna on a side of the second casing 112.

FIG. 5 is a diagram illustrating another example of the mobile terminal devices in which a call antenna and a 1 seg antenna are disposed at different positions. FIG. 5 illustrates the same components as those of FIG. 4 using the same reference numerals. In a mobile terminal device 120 shown in FIG. 5, an internal antenna 121 is disposed at the opposite ends of the second casing 112 to the hinge 113.

The known mobile terminal devices shown in FIGS. 4 and 5 have a special space for disposing the 1 seg antenna at a side or end of the second casing 112. Providing the special space for the antenna poses the problem of hindering size reduction of the device.

Thus, to solve such a problem, known mobile terminal devices use a hinge that joins the two casings as an antenna for a purpose other than for calling. In these mobile terminal devices, the hinge is formed of an electrically conductive material. The hinge is supplied with electricity from a circuit board provided in the casing and thus functions as an antenna for receiving radio waves from a global positioning system (GPS).

Since these mobile terminal devices use the hinge itself as a GPS antenna, there is no need to provide another space for a GPS antenna to a casing joined with the hinge. Accordingly, the devices can be reduced in size.

Japanese Laid-open Patent Publication Nos. 2007-88692 and 2009-94859 are examples of related art

However, the mobile terminal device described above has a problem in that the hinge cannot be used as a 1 seg antenna.

Specifically, the foregoing mobile terminal device uses the hinge as a GPS antenna. The frequency range of a GPS radio wave is about 1,575 MHz, and the corresponding electrical length of the hinge is about 20 to 30 mm. On the other hand, the frequency band of a 1 seg radio wave is relatively low and wide (about 400 to 800 MHz). Therefore, if the hinge of the above mobile terminal device is used as a 1 seg antenna, its electrical length is insufficient. Thus, the above mobile terminal device cannot use the hinge as a 1 seg antenna.

### SUMMARY

According to an aspect of the embodiment, a mobile terminal device includes: a first casing having a first antenna element; a second casing having a second antenna element; and a joint for rotatably joining the first casing and the second casing, the joint having third antenna element for electrically connecting the first antenna element and the second antenna element.

The object and advantages of the embodiment will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an outside perspective view of a mobile phone according to an embodiment;

FIG. 2 is an enlarged perspective view illustrating the periphery of a joint portion of the mobile phone according to the embodiment;

FIG. 3 is a block diagram illustrating the configuration of a 1 seg circuit unit;

FIG. 4 illustrates an example of a mobile terminal device in which a call antenna and a 1 seg antenna are disposed at different positions; and

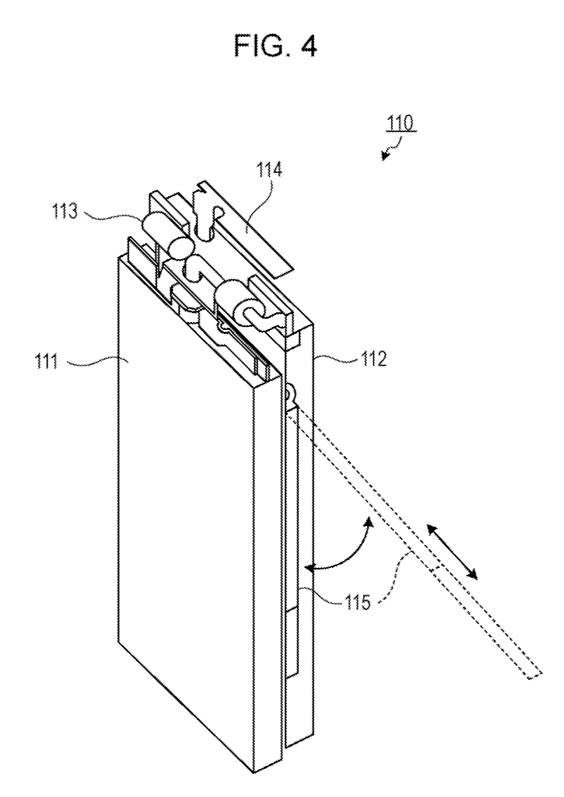

FIG. 5 is illustrates another example of the mobile terminal device in which a call antenna and a 1 seg antenna are disposed at different positions.

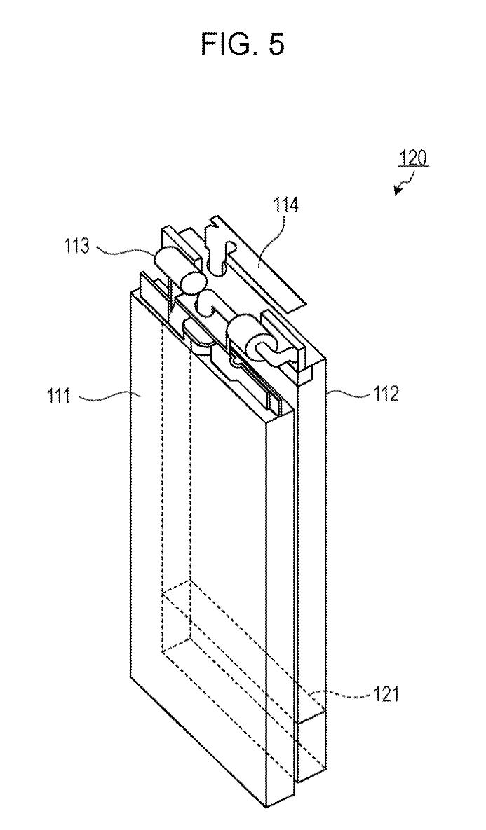

### DESCRIPTION OF EMBODIMENTS

An embodiment of a mobile terminal device laid open in this application will be described hereinbelow with reference to the drawings.

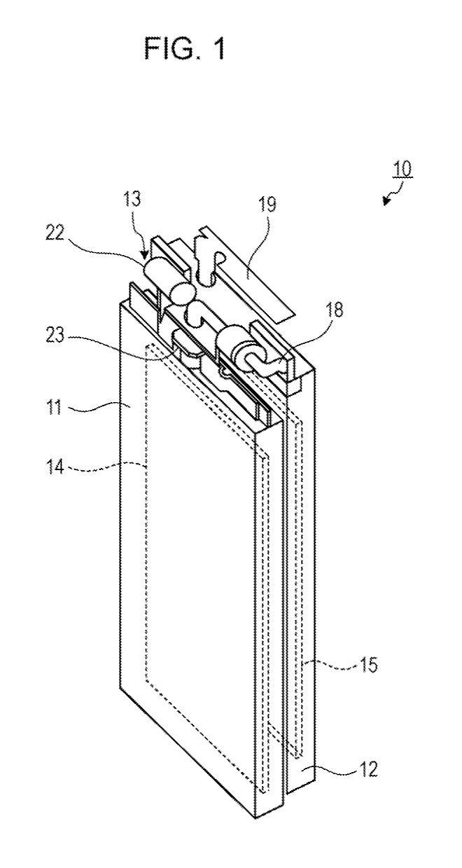

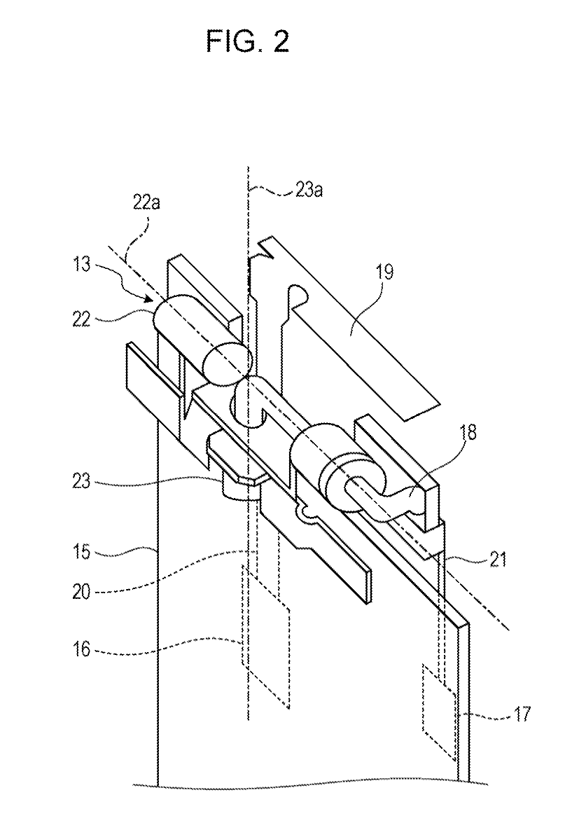

This embodiment is an example in which the mobile terminal device laid open in this application is applied to a folding mobile phone. FIG. 1 is an outside perspective view of the mobile phone according to this embodiment. FIG. 2 is an enlarged perspective view illustrating the periphery of a joint portion of the mobile phone according to this embodiment.

As shown in FIGS. 1 and 2, the mobile phone 10 includes a first casing 11 on the display side and a second casing 12 on the operating section side. The first casing 11 and the second casing 12 are movably joined together with a joint portion 13. The first casing 11 and the second casing 12 are shaped like a box from, for example, a lightweight high-strength magnesium alloy. An outer cover (not shown) for preventing exposure of the joint portion 13 is provided in the vicinity of the joint portion 13. FIG. 1 shows a state in which the first casing 11 and the second casing 12 are put one on another by rotating the second casing 12 to the first casing 11.

The first casing 11 has a circuit board 14, a receiver, a display formed of a liquid crystal display (LCD) device (not shown), etc. On the other hand, the second casing 12 has a circuit board 15, operation keys, a microphone (not shown), etc.

As shown in FIG. 2, the circuit board 15 of the second casing 12 has a radio circuit unit 16 for voice calls, a 1 seg circuit unit 17, which is a radio circuit for 1 seg broadcasting, a processing circuit unit including a processor and a memory (not shown), etc. The circuit board 14 of the first casing 11 and the circuit board 15 of the second casing 12 are electrically connected by a connecting cable 18 that passes through the joint portion 13.

A call antenna 19 for voice calls is disposed at the joint portion 13 side of the second casing 12. The call antenna 19 is connected to the radio circuit unit 16 of the circuit board 15 via a conductive member 20, such as a flexible cable. The call antenna 19 transmits and receives radio waves in a first frequency band by being supplied with electricity from the radio circuit unit 16. The radio circuit unit 16 performs a predetermined process necessary for radio call, such as demodulation, on reception signals in the first frequency band input through the call antenna 19.

An example of the first frequency band is a relatively high frequency narrow band, such as 2 GHz, which is a frequency band for voice calls.

The joint portion 13 is a hinge module formed of an electrically conductive material, such as metal, and rotatably joins the first casing 11 and the second casing 12. The joint portion 13 is connected to the 1 seg circuit unit 17 of the circuit board 15 via a conductive member 21 such as a metal plate. The joint portion 13 has a predetermined electrical length that allows reception of radio waves in a second frequency band that is lower and wider than the first frequency band and receives radio waves in the second frequency band by being supplied with electricity from the 1 seg circuit unit 17.

Assuming that the first frequency band is a 2 GHz band for voice calls, the second frequency band is a relatively low and wide frequency band, such as 400 MHz to 800 MHz bands, for 1 seg broadcasting.

Specifically, the joint portion 13 includes a first hinge 22 and a second hinge 23. Each of the first hinge 22 and the second hinge 23 is conductive metal. The first hinge 22 joins the first casing 11 and the second casing 12 rotatably about a first shaft 22a. The second hinge 23 joins the first casing 11 and the second casing 12 rotatably about a second shaft 23a perpendicular to the first shaft 22a.

The first hinge 22 has a first antenna element, a second antenna element, and a third antenna element. The first casing 11 has the first antenna element. The second casing 12 has the second antenna element. The first hinge 22 has a first joint for rotatable joining the first antenna element and the second antenna element conductively. The first joint can have a first roller as the third antenna element for connecting the first antenna element with the second antenna element conductively. The total length of the first, second and third antenna elements can correspond to an electrical length for receiving a radio wave of 1 seg broadcasting. The third antenna element can be a roller fixed with the first antenna element. The roller contacts with the second antenna element.

The second hinge 23 has a fourth antenna element, a fifth antenna element, and a sixth antenna element. The first casing 11 has the fourth antenna element. The second casing 12 has the fifth antenna element. The second hinge 23 has a second joint for rotatable joining the fourth antenna element and the fifth antenna element conductively. The second joint can have a second roller as the sixth antenna element for connecting the fourth antenna element with the fifth antenna element conductively. The total length of the fourth, fifth and sixth antenna elements can correspond to an electrical length for receiving a radio wave of 1 seg broadcasting. The sixth antenna element can be a roller fixed with the fourth antenna element. The roller contacts with the fifth antenna element.

The first hinge 22 is connected with the second hinge 23 conductively. The first antenna element or the second antenna element of the hinge 22 can be the same as the fourth antenna element of the hinge 23. The total electrical length of the joint portion 13 including the length of the first hinge 22 and the length of the second hinge 23 can be set to one quarter of the wavelength of radio waves in the second frequency band. By setting the total electrical length at one quarter of the radio waves in the second frequency band, the joint portion 13 functions as an antenna that resonates with the radio waves in the second frequency band. Thus, the mobile phone 10 can efficiently receive the radio waves in the second frequency band.

The 1 seg circuit unit 17 supplies electricity to the joint portion 13 and performs a predetermined process necessary for receiving 1 seg broadcasts, such as demodulation, on reception signals in the second frequency band input through the joint portion 13. A concrete configuration of the 1 seg circuit unit 17 will be described hereinbelow.

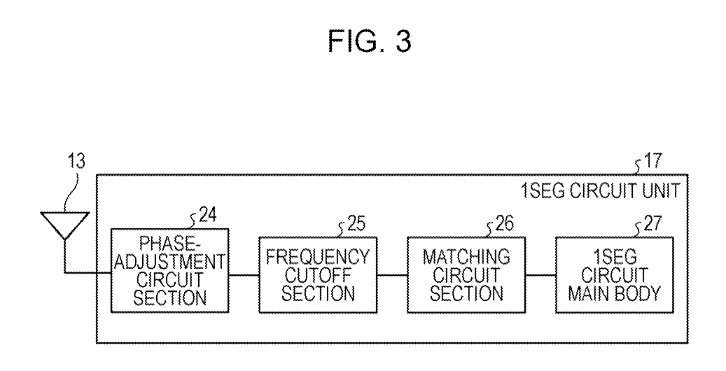

FIG. 3 is a block diagram illustrating the configuration of the 1 seg circuit unit 17. As shown in FIG. 3, the 1 seg circuit unit 17 includes a phase-adjustment circuit section 24, a frequency cutoff section 25, a matching circuit section 26, and a 1 seg-circuit main body 27.

The phase-adjustment circuit section 24 adjusts the phase of an electric current flowing through the joint portion 13 so that the reception characteristic of the joint portion 13 for radio waves in the second frequency band can be maintained. Furthermore, the phase-adjustment circuit section 24 adjusts the phase of an electric current flowing through the joint portion 13 so that the phase of an electric current flowing through the call antenna 19 and the phase of the electric current flowing through the joint portion 13 have phases other than opposite phases.

The frequency cutoff section 25 is formed of, for example, a low-pass filter, a high-pass filter, or a band-pass filter. The frequency cutoff section 25 cuts off the first frequency band received by the call antenna 19 and allows the second frequency band received by the joint portion 13 to pass through.

The matching circuit section 26 matches the impedance of the joint portion 13 to the input impedance of the 1 seg-circuit main body 27 to rectify an electric current flowing between the joint portion 13 and the 1 seg-circuit main body 27.

The 1 seg-circuit main body 27 supplies electricity to the joint portion 13, demodulates reception signals in the second frequency band input from the joint portion 13, and displays an image on the display (not shown) provided on the first casing 11 using the demodulated signals.

As has been described above, in this embodiment, the conductive joint portion 13 that joins the first casing 11 and the second casing 12 has a predetermined electrical length that allows reception of radio waves in the second frequency band lower and wider than the first frequency band of radio waves received by the call antenna 19. The joint portion 13 receives radio waves in the second frequency band by being supplied with electricity from the circuit board 15 of the second casing 12. Thus, according to this embodiment, the mobile phone 10 can use the joint portion 13 that joins the casings as an antenna for receiving relatively low-frequency wide-band radio waves like radio waves for 1 seg broadcasting.

Furthermore, in this embodiment, the joint portion 13 includes the first hinge 22 and the second hinge 23, and the electrical length including the length of the first hinge 22 and the length of the second hinge 23 is set to one quarter of the wavelength of the radio waves in the second frequency band. Thus, according to this embodiment, the mobile phone 10 can easily ensure the electrical length of the joint portion 13 for receiving relatively low-frequency wide-band radio waves like radio waves for 1 seg broadcasting.

Furthermore, this embodiment includes the phase-adjustment circuit section 24, at the circuit board 15, for adjusting the phase of an electric current flowing through the joint portion 13 so that the reception characteristic of the joint portion 13 for radio waves in the second frequency band can be maintained. Thus, according to this embodiment, even if the phase of an electric current flowing through the joint portion 13 changes with the movement of the joint portion 13, the mobile phone 10 can stably receive relatively low-frequency wide-band radio waves like radio waves for 1 seg broadcasting.

Furthermore, in this embodiment, the phase-adjustment circuit section 24 adjusts the phase of an electric current flowing through the joint portion 13 so that the phase of an electric current flowing through the call antenna 19 and the phase of the electric current flowing through the joint portion 13 have phases other than opposite phases. Thus, according to this embodiment, the mobile phone 10 can avoid interference between the electric current flowing through the call antenna 19 and the electric current flowing through the joint portion 13. This allows the mobile phone 10 to prevent degradation of the antenna characteristics of both of the call antenna 19 and the joint portion 13.

Furthermore, in this embodiment, the circuit board 15 includes the frequency cutoff section 25 that cuts off the first frequency band received by the call antenna 19 and allows the second frequency band received by the joint portion 13 to pass through. Thus, according to this embodiment, the mobile phone 10 can prevent part of radio waves in the first frequency band received by the call antenna 19 from being caught by the joint portion 13. This allows the mobile phone 10 to further prevent degradation of the antenna characteristics of both of the call antenna 19 and the joint portion 13.

In this embodiment, description is made on the technology for receiving radio waves in different frequency bands by a folding mobile phone using a hinge module. The above technology can be applied not only to the folding mobile phones using the illustrated hinge module but also to folding mobile phones using other various hinge modules. Furthermore, the above technology can be applied not only to the folding type using the hinge module but also to mobile phones in which a movable casing can be moved relative to a fixed casing using, for example, a slide type or a plane rotating type of joint portion.

Furthermore, while this embodiment has been described when applied to a mobile phone as a mobile terminal device, the present invention is not limited thereto. For example, the present invention can also be applied to other various mobile terminal devices such as compact information processing terminals like personal digital assistants (PDAs), compact music playback units, portable TVs, and mobile game machines.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A mobile terminal device comprising:
a first casing having a first antenna element;
a second casing having a second antenna element; and
a joint for rotatably joining the first casing and the second casing, the joint having third antenna element for electrically connecting the first antenna element and the second antenna element.

2. The mobile terminal device of claim 1, wherein the total length of the jointed first, second and third antenna elements corresponds to an electrical length for receiving a radio wave of a first frequency band.

3. The mobile terminal device of claim 2, wherein the joint keeps a distance between the first antenna element and the second antenna element not to change an antenna characteristic of the jointed first, second and third antenna elements.

4. The mobile terminal device of claim 3, wherein the third antenna element is a roller fixed with the first antenna element, the roller contacting with the second antenna element.

5. The mobile terminal device of claim 2, further comprising:
an antenna for receiving a radio wave of a second frequency band; and
a phase-adjustment circuit for adjusting a phase of an electric current flowing through the jointed first, second and third antenna elements so as to have other than opposite phase of an electric current of the antenna for receiving the radio wave of the second frequency band.

6. The mobile terminal device of claim 5, further comprising a frequency cutoff section for cutting off the second frequency band and for allowing the first frequency band.
